(19) United States
(12) Patent Application Publication
(10) Pub. No.: US 2007/0133677 A1
(43) Pub. Date: Jun. 14, 2007

(54) Method and apparatus for encoding and decoding video signals on group basis

(75) Inventors: Woo-jin Han, Suwon-si (KR); Bae-keun Lee, Bucheon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/637,074

(22) Filed: Dec. 12, 2006

Related U.S. Application Data
(60) Provisional application No. 60/749,065, filed on Dec. 12, 2005.

(30) Foreign Application Priority Data
Apr. 6, 2006 (KR) 10-2006-0031650

(51) Int. Cl. H04B 1/66; H04N 11/04

(52) U.S. Cl. 375/240.1; 375/240.24

(57) ABSTRACT

A method and apparatus for encoding and decoding a video signal on a group basis is disclosed, in which blocks constituting a multi-layer video signal are coded. The method includes grouping every two or more blocks having symbols that have a value identical to a predetermined value, generating group-based symbols each indicating information about the grouped blocks, and coding the group-based symbols.

### CROSS-REFERENCE TO RELATED APPLICATION

This application claims priority from Korean Patent Application No. 10-2006-0031650 filed on Apr. 6, 2006, in the Korean Intellectual Property Office, and U.S. Provisional Patent Application No. 60/749,065 filed on Dec. 12, 2005, in the United States Patent and Trademark Office, the disclosures of which are incorporated herein by reference in their entirety.

### BACKGROUND OF THE INVENTION

1. Field of the Invention

The present invention relates to the encoding and decoding of video signals and, more particularly, to a method and apparatus for encoding and decoding video signals on a group basis.

2. Description of the Related Art

As information and communication technology, including the Internet, develops, image-based communication as well as text-based communication and voice-based communication is increasing. The existing text-based communication is insufficient to satisfy consumers' various demands. Therefore, the provision of multimedia service capable of accommodating various types of information, such as text, images and music, is increasing. Since the size of multimedia data is large, multimedia data require high-capacity storage media, and require broad bandwidth at the time of transmission. Therefore, to transmit multimedia data, including text, images and audio, it is essential to use a compression encoding scheme.

The fundamental principle of data compression is to eliminate redundancy from data. Data can be compressed by eliminating spatial redundancy such as the case where an identical color or object is repeated in an image, temporal redundancy, such as a case where there is little change between neighboring frames or an identical audio sound is repeated, or psychovisual redundancy, in which the fact that humans' visual and perceptual abilities are insensitive to high frequencies is taken into account. In a general coding method, temporal redundancy is eliminated using temporal filtering based on motion compensation, and spatial redundancy is eliminated using spatial transform.

Redundancy-free data is subjected to lossy coding based on a predetermined quantization step through a quantization process again. Quantized data are losslessly coded through entropy coding.

Recently, as disclosed in the draft of Scalable Video Coding (hereinafter referred to as “SVC”), being prepared by JVT (Joint Video Team; the video experts group of ISO/IEC (International standards organization/International Electrotechnical Commission)) and ITU (International Telecommunication Union), research into a multi-layer-based coding technique based on existing H.264 has been actively carried out, as shown in the example of FIG. 1.

FIG. 1 is a diagram illustrating block-based Variable Length Coding (VLC). VLC is a kind of a statistical feature-based lossless compression method. VLC is a method of assigning codewords having different lengths according to the probability of occurrence of an input symbol, in order to improve compression performance. A representative example of the method is Huffman coding.

Table 1 shows Exp-Golomb codes used in the baseline profile of H.264. In view of the feature of H.264, in which the differences with a predicted value are coded for almost all symbols, values close to 0 frequently occur, therefore all bits are minimized in such a way that the length of bits assigned to each value is inversely proportional to the distance between the value and 0.

TABLE 1

| Code_num | Codeword |
|---|---|
| 0 | 1 |
| 1 | 010 |
| 2 | 011 |
| 3 | 00100 |
| 4 | 00101 |
| 5 | 00110 |
| 6 | 00111 |
| 7 | 0001000 |
| 8 | 0001001 |
| . . . | . . . |

Most image compression methods, including H.264, perform compression on a macroblock basis. That is, when the VLC method is applied, coding is performed on a macroblock or subblock basis. For example, in the case of a Coded Block Pattern (CBP) defined in the macroblock syntax of H.264, 6 bits are assigned to each macroblock. The 6 bits are represented using Exp-Golomb code for each macroblock, and are then coded.

FIG. 1 illustrates a block-based VLC compression method. Symbols (x, y) existing in each block are compared with a VLC table, and corresponding codewords (c(x), c(y)) are stored in a bit stream.

A problem inherent in the existing VLC method is that the minimum number of bits of each symbol is 1. For example, when there are 100 symbols in one frame, 100 bits are required even if all of the 100 symbols have a value of 0. This is because the similarity between neighboring symbols is not taken advantage of to the greatest extent. In contrast, in the case of arithmetic coding, the number of bits of each symbol can be set to a value equal to or smaller than 1, therefore the arithmetic coding method is advantageous in that it enables more efficient coding when the similarity between neighboring symbols is very high.

Since H.264 Scalable Extension (SE) has a multi-layer structure, the number of bits assigned to an upper layer is significantly smaller than that for a general single-layer structure. Accordingly, lots of symbols become 0 in the upper layer, which means that the similarity between neighboring symbols is higher than that in the existing single layer H.264. In particular, this phenomenon is more prominent in a low bit rate environment.

For example, the coded block pattern (CBP) of H.264 is a flag indicating whether there is a coefficient to be actually coded within a corresponding 8×8 subblock. In a single layer, the CBP rarely becomes 0. However, in a multi-layer structure, the CBP frequently becomes 0 in an upper layer because excellent prediction signals can be obtained from a lower layer in many cases. In this case, it is difficult to utilize the phenomenon to the greatest extent using VLC.

Therefore, in the case of H.264 SE, an upper layer requires a method of solving the problem inherent in the existing VLC.

### SUMMARY OF THE INVENTION

Accordingly, the present invention has been made keeping in mind the above problems occurring in the prior art, and an aspect of the present invention is to provide a method and apparatus for increasing the efficiency of the coding of symbols having the same information.

Another aspect of the present invention is to increase the compression ratio by eliminating overlapping information in blocks.

The present invention provides a method of coding blocks constituting a multi-layer video signal, the method including grouping every two or more blocks having symbols that have a value identical to a predetermined value; generating group-based symbols each indicating information about the grouped blocks; and coding the group-based symbols.

Additionally, the present invention provides a method of decoding blocks constituting a multi-layer video signal, the method including extracting information about grouping of blocks having symbols that have a value identical to a predetermined value; determining whether the blocks constituting the video signal have been coded based on the extracted grouping information; and extracting the predetermined value based on a result of the determination, and decoding the blocks.

Additionally, the present invention provides a video encoder for coding blocks constituting a multi-layer video signal, the video encoder including a grouping determination unit determining a method of grouping every two or more blocks having symbols that have a value identical to a predetermined value; a pass bit setting unit setting at least one pass bit for group-based symbols each indicating information about the grouped blocks; and a symbol encoding unit coding the group-based symbols.

Additionally, the present invention provides a video decoder for decoding blocks constituting a multi-layer video signal, the video decoder including a grouping information extraction unit extracting information about grouping of blocks having symbols that have a value identical to a predetermined value; a pass bit determination unit determining whether the blocks constituting the video signal have been coded based on the extracted information; and a symbol generation unit extracting the predetermined value based on a result of the determination, and decoding the blocks.

The details of other exemplary embodiments are included in the detailed description and the accompanying drawings.

### BRIEF DESCRIPTION OF THE DRAWINGS

The above and other aspects, features and advantages of the present invention will be more clearly understood from the following detailed description taken in conjunction with the accompanying drawings, in which:

FIG. 1 is a diagram illustrating block-based VLC;

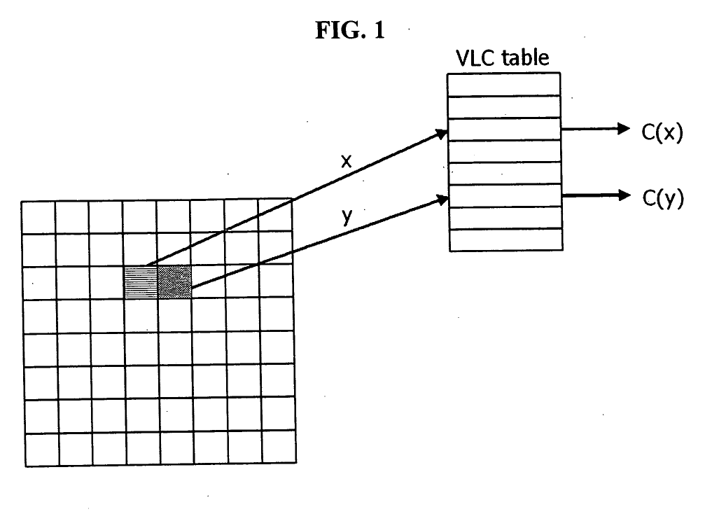

FIG. 2 is a diagram illustrating a group symbol coding process according to an exemplary embodiment of the present invention;

FIG. 3 is a diagram illustrating an example of coding symbols according to an exemplary embodiment of the present invention;

FIG. 4 is a diagram illustrating an example of coding symbols according to another exemplary embodiment of the present invention;

FIG. 5 is a diagram illustrating an encoding sequence of setting pass bits on a group basis according to an exemplary embodiment of the present invention;

FIG. 6 is a diagram illustrating an encoding sequence of setting pass bits and performing run-length coding (RLC) on the pass bits according to an exemplary embodiment of the present invention;

FIG. 7 is a diagram illustrating a decoding sequence according to an exemplary embodiment of the present invention;

FIG. 8 is a block diagram illustrating the construction of the entropy encoding unit of an encoder according to an exemplary embodiment of the present invention; and

FIG. 9 is a block diagram illustrating the construction of the entropy decoding unit of a decoder according to an exemplary embodiment of the present invention.

### DESCRIPTION OF THE EXEMPLARY EMBODIMENTS

The present invention will now be described in detail in connection with exemplary embodiments with reference to block diagrams and flowcharts illustrating a method and apparatus for encoding and decoding video signals on a group basis. It is to be understood that each block of the processing flowchart drawings and a combination of the flowchart drawings can be executed by computer program instructions. The computer program instructions can be loaded into the processing unit of a general-purpose computer, a special purpose computer, and other programmable data processing equipment. Therefore, the instructions executed by the processing units of the computers or other programmable data processing equipment create means for performing functions described in flowchart block(s). The computer program instructions can be stored in a computer-available or computer readable memory that can be provided to the computer or other programmable data processing equipment in order to implement the functions in a specific manner. Therefore, the instructions stored in the computer-available or computer readable memory can produce manufacturing articles including the instruction means for performing the functions described in the flowchart block(s). Since the computer program instructions can be mounted on the computer or other programmable data processing equipment, a series of operating steps is performed on the computer or other programmable data processing equipment to create a process executed by the computer. Accordingly, the instructions that execute the computer or other programmable data processing equipment can be provided as steps of executing the functions described in the flowchart block(s).

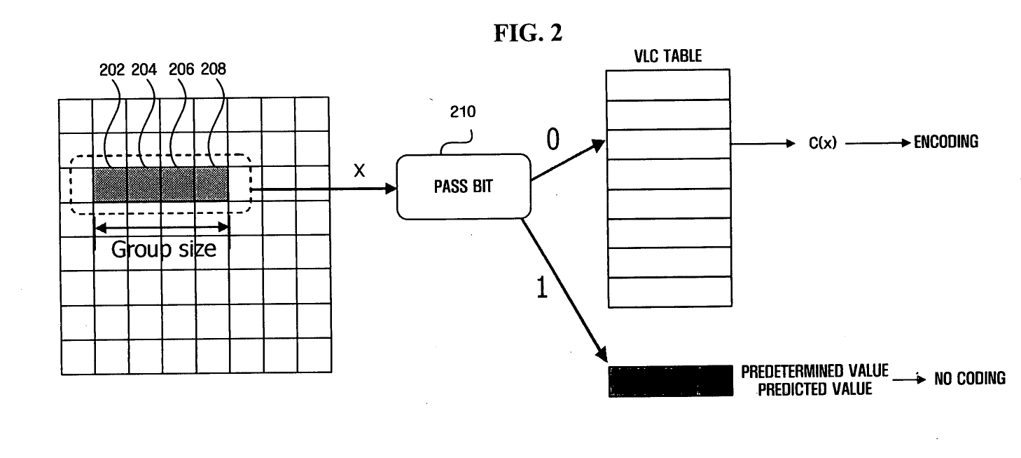

FIG. 2 is a diagram illustrating a group symbol coding process according to an exemplary embodiment of the present invention.

When there is a predetermined group size N, every N symbols are grouped and coded. That is, in FIG. 2, symbols included in four blocks 202, 204, 206, and 208 can be grouped into one group. In this case, if the value of each symbol is identical to a predetermined value or a value predicted with reference to other information, coding is not performed on the symbol. Furthermore, to indicate whether the values of the N symbols of the blocks are identical to the predetermined value or the predicted value, a pass bit is set. If they are identical to the value, the pass bit is set to 0, and blocks included in a corresponding group are not coded. If they are not identical to the value, the pass bit is set to 1 and conventional VLC coding is performed.

That is, the N symbols are regarded as a single group, and a predicted value (or a predetermined value) is obtained for the N symbols. If the N symbols are all identical to the predicted value, the pass bit is set to 1 and all of the N symbols are skipped without being coded. If there is a value that is not identical to the predicted value, the pass bit is set to 0, and VLC is performed with the N symbols regarded as a single symbol, or VLC is performed on the N symbols using the conventional method.

In this case, assuming that the total number of symbols is M, M/N pass bits are required. This necessitates additional M/N bits, compared to the conventional method. If the case where the pass bit is 1 frequently occurs, it is not necessary to code the N symbols, thereby resulting in improved compression performance.

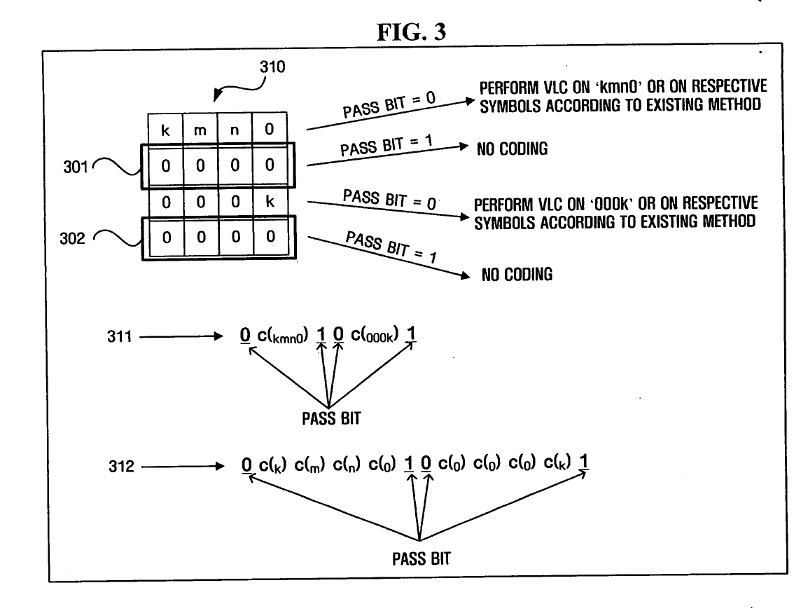

FIG. 3 is a diagram illustrating an example of coding symbols according to an exemplary embodiment of the present invention. FIG. 3 shows the case in which the value of N is 4. For convenience of description, a set of 4×4 blocks 310 will be taken as an example. However, the implementation of the present invention is not limited to the above example, but is performed in association with a larger number of blocks (subblocks or macroblocks), slices or frames. In the present specification, the term “block” signifies a block, a subblock, or a macroblock. The block is embodied as an 8×8 block, a 4×4 block or a motion partition block.

In FIG. 3, when the values of the symbols of respective blocks within the set of the blocks 310 are k, m, n and 0, the pass bit is used when the four blocks all have a value of 0. Therefore, for first four blocks, the pass bit is set to 0 and coding is performed on each symbol or on the four blocks (‘kmn0’) as a whole.

Since the symbol values of four subsequent blocks 301 are all 0, the pass bit is set to 1 and coding is not performed. In the four blocks of the third column, the symbol value of the last block is k, therefore the pass bit is set to 0 and coding may be performed on each symbol or on “000k”, as in the first bit. In the four blocks 302 of the fourth column, the four blocks are all 0, therefore the pass bit is set to 1 and coding is not performed, as in the blocks 301.

As described above, the coding process is classified as a case 311 in which four symbols are grouped and then coded, or a case 312 in which each of four symbols is coded. In this case, the value of 0 is only illustrative, and the value may be a predetermined value or a value generated from a residual with a predicted value. For example, when the difference with predicted data is 0, the value of 0 may be a reference for setting the pass bit.

Furthermore, in the cases 311 and 312, the pass bits and data to be coded are mixed together. However, the pass bits and the data to be coded may be sent separately. These may depend on coding methods that are used in a video stream at the time of video encoding.

When the pass bit is 1, the decoder side uses a predetermined value or obtains a predicted value and sets N-symbol values based on the value. When the pass bit is 0, the decoder side parses the N symbols in the same manner as the conventional method. This process is very simple, therefore almost no additional computation work is required.

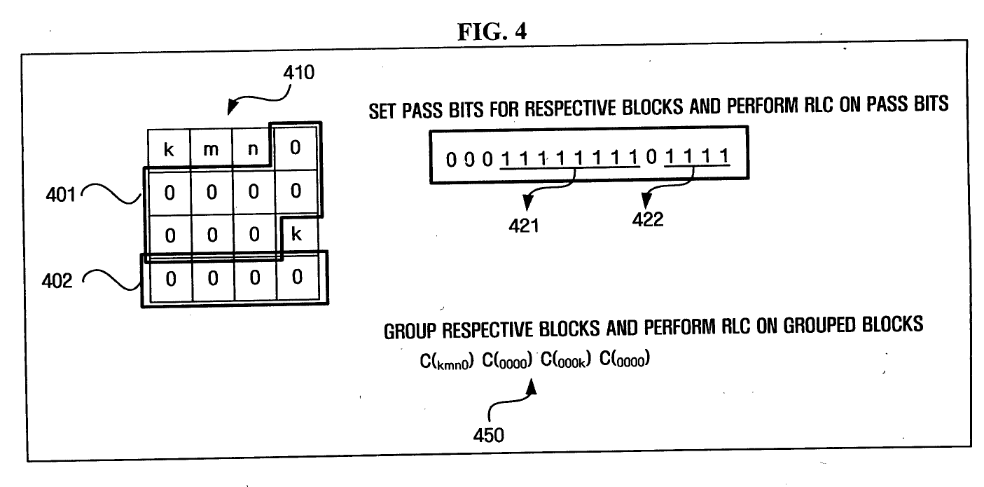

Unlike FIG. 3, in which a pass bit is set for each group itself, FIG. 4 shows a method in which the group size is not fixed to N, each symbol is set to 0 when the value of the symbol is identical to a predicted value or a predetermined value, and coding is performed based on an RLC method when M or more 0s occur. However, if the length of 0s is great, efficiency may be lowered when a run is assigned to 0s having a long length. Therefore, in the exemplary embodiment of FIG. 4, a limit value M for the maximum length of 0s is set to 8. A set of blocks 401 is identical to that of FIG. 3. The pass bit is set to 1 or 0 depending on the values of respective blocks. Since the symbol value of each block is identical to a predicted value or predetermined value, the pass bit is set to 1 so as to indicate the fact that coding will not be performed. In contrast, the pass bit is set to 0 in other cases. Therefore, the pass bits for blocks 401 are continuous 1s, as indicated by the reference numeral 421, and the pass bits for blocks 402 are continuous 1s, as indicated by the reference numeral 422.

If the pass bits are compressed again through RLC, a predetermined or predicted value can be used on the decoder side even though a corresponding block has no encoded value when the pass bit is 1. Therefore, coding efficiency can be increased because it is not necessary to send coded values separately.

In addition to the above method, RLC can be performed without setting the pass bit with respect to each grouped symbol. In the example of FIG. 4, if four blocks are grouped into one group and symbols are coded, an implementation 450 may be obtained.

For example, RLC can be performed on kmn0 (for a first group), 0000 (for a second group), 000k (for a third group), and 0000 (for a fourth group). For example, the values of the CBPs or residual prediction flags of blocks may be grouped in as many as a group size, and symbols can be coded.

In this process, the maximum value of a run may be limited in order to prevent the length of the run from being excessively long, because most values are 0.

In other words, when the possibility that information existing in blocks may have the same value is high, coding can be performing after grouping in order to increase bit efficiency. An exemplary embodiment of the grouping may include setting a pass bit or performing RLC on a block basis through grouping.

At the time of encoding the value of a run, the VLC method can be used. An exemplary embodiment of the VLC method includes the Exp-Golomb coding and the Universal VLC (UVLC) coding.

Furthermore, the set values 1 and 0 of the pass bit used in FIG. 3 or 4 may vary with the implementation. That is, when data is identical to a predicted value or predetermined value, the pass bit may be set to 1 or 0. This depends on an agreement between the encoder side and the decoder side.

The examples of FIGS. 3 and 4 may be applied to the various symbols of blocks (subblocks or macroblocks). If there are many values that are identical to the predicted value, information may be provided to indicate whether a predicted value will be used without change.

For example, in H.264 SE, a residual prediction flag is included in each block. If the residual prediction flag is 1, the residual information of a lower layer is utilized when the residual of an upper layer is coded. Since the residual prediction flag occupies one bit of each block, 0 or 1 is simply stored in the bit stream, unlike VLC. The residual prediction flag has a close relationship with the residual energy of the lower layer. For example, when the residual energy of the lower layer is not 0, the probability that the residual prediction flag is 1 is high. When the residual energy of the lower layer is 0, the probability that the residual prediction flag is 0 is high.

Therefore, to use the group VLC of FIG. 3 or 4, a value “isBaseResidualAvailable(n)” may be defined. The value is a variable that has a value of 1 when the residual energy of the lower layer is not 0, and that has a value of 0 when the residual energy of the lower layer is 0, with respect to an nth block. In other words, if, with respect to group size N, the values of N residual prediction flags are identical to the value “isBaseResidualAvailable(n)”, the pass bit is set to 1, 1 is recorded in a bit stream, and the residual prediction flags are not coded. Otherwise, the pass bit is set to 0, 0 is recorded in the bit stream, and the N residual prediction flags are written in the bit stream. At this time, the N residual prediction flags can be written in the bit stream using N bits, respectively, and can be coded using N-bit Exp-Golomb code, which has already been described with reference to FIG. 3.

The same method may be applied to CBP coding. A CBP consists of 6 bits (4 luma bits and 2 chroma bits). CBPs are correspondingly encoded using Exp-Golomb code on a block basis. Like the case where residual prediction flags are used, for H.264 SE, there are many cases where the entire CBP is 0 in the upper layer. In this case, the current use of Exp-Golomb code is not inefficient. Therefore, when pass bits are used and are all 0, as described above, the pass bits may be set to 1, and N CBPs may be skipped without being coded.

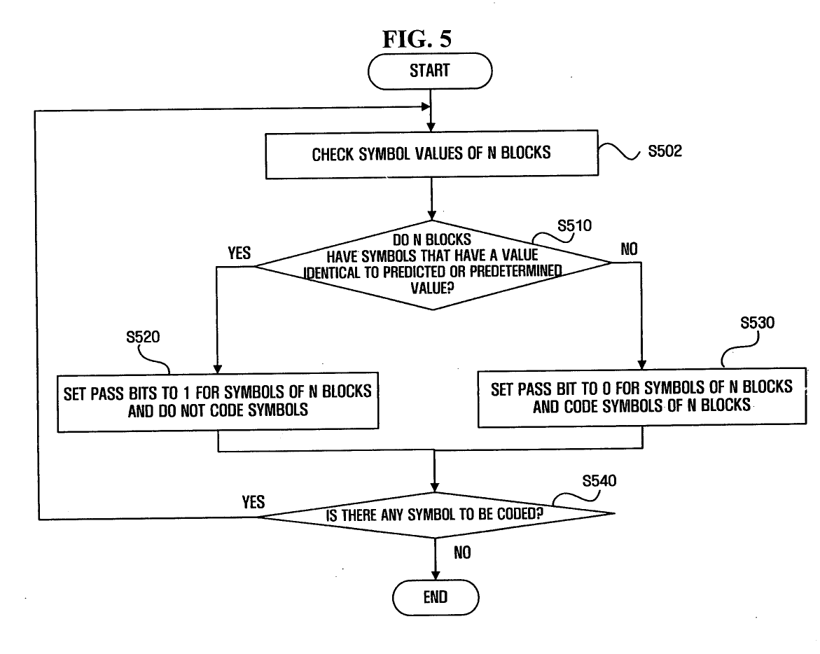

FIG. 5 is a diagram illustrating an encoding sequence of setting pass bits on a group basis according to an exemplary embodiment of the present invention.

N symbol values (where N is group size) are checked at step S502. The symbol values may include various values constituting blocks, such as residual prediction flags and CBPs. Thereafter, whether all the symbol values of the N blocks are identical to a predicted value or predetermined value is determined at step S510.

If it is determined that all the symbol values of the N blocks are identical to the predicted value or predetermined value, pass bits are set to 1 for all of the symbols, and the corresponding symbols are not coded at step S520. In contrast, if any one of the symbols of the N blocks has a value different from the predicted value or predetermined value, pass bits are set to 0 for the symbols of the N blocks at step S530.

Whether there are symbols to be subsequently coded is determined at step S540. If it is determined that there are symbols to be subsequently coded, the process returns to step S502 of determining whether all the values of the N symbols are identical to the predetermined or predicted value. Information about the pass bits, along with the coded symbols, may be added to the bit stream.

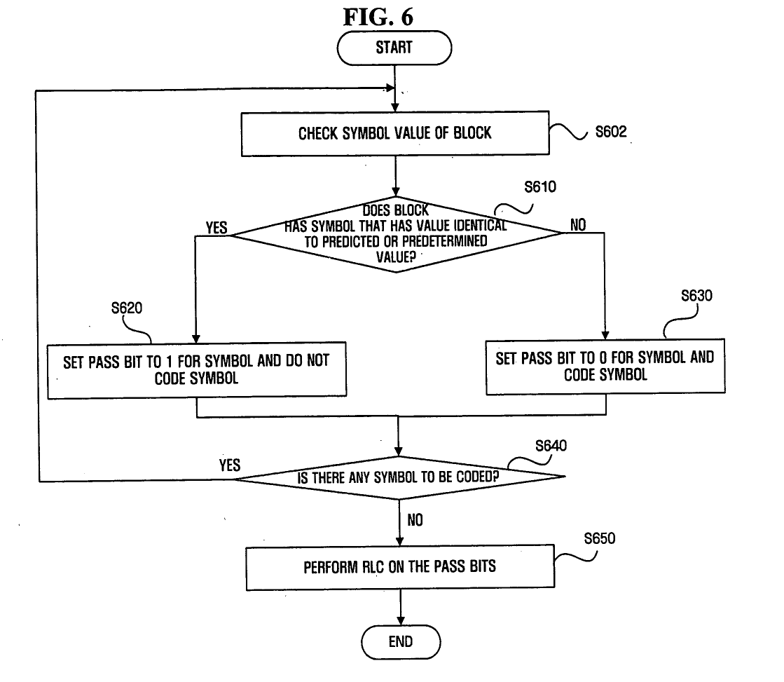

FIG. 6 is a diagram illustrating an encoding sequence of setting pass bits and performing RLC on the pass bits according to an exemplary embodiment of the present invention.

The symbol value of a block is checked at step S602. Thereafter, whether the symbol value is identical to a predicted value or predetermined value is determined at step S610.

If it is determined that the symbol value is identical to the predicted or predetermined value, a pass bit for the symbol is set to 1 and the symbol is not coded at step S620. However, if it is determined that the symbol does not have the same value as the predicted value or predetermined value, the pass bit is set to 0 and coding is performed on the symbol at step S630.

Thereafter, whether there are symbols to be coded is determined at step S640. If it is determined that there are symbols to be coded, the process returns to step S602. Meanwhile, if it is determined that there are no symbols to be coded, RLC is performed on the pass bits at step S650. In this case, if the values of the pass bits are a long series of continuous is, a run may be constructed to correspond to a predetermined length, and then the symbols may be coded. The run, along with the coded symbols, may be added to a bit stream.

As described with reference to FIGS. 5 and 6, it is necessary to transmit information about groups and group-based pass bits. Information about groups can be previously set and can be transmitted at regular intervals. For example, in the case where group information is set on a frame basis or on a slice basis, a group value is separately set in the bit stream. Furthermore, the pass bits may be transmitted along with the symbols of blocks, or pass bits corresponding to group size may be previously transmitted.

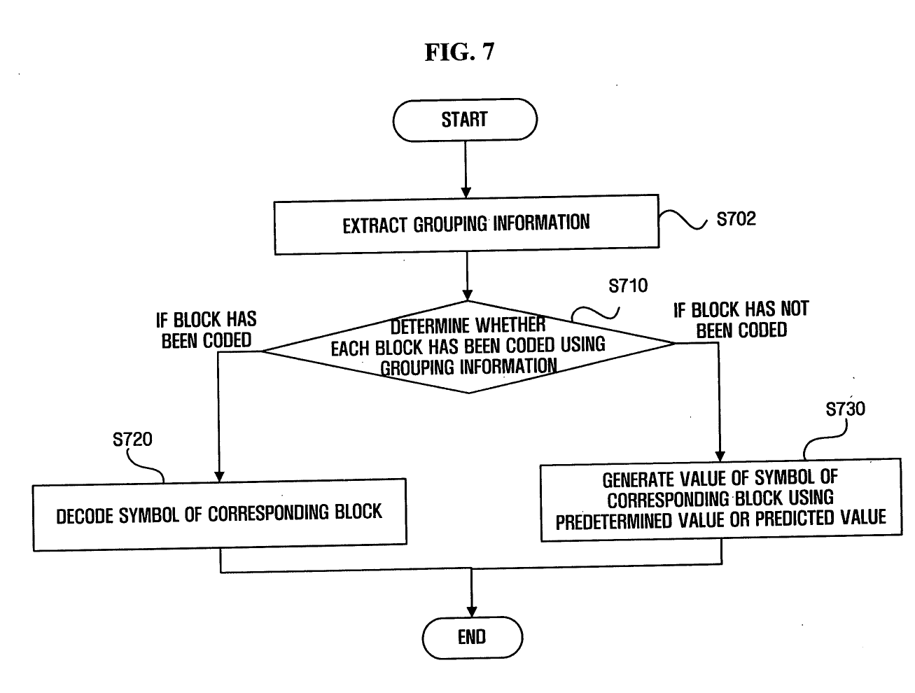

FIG. 7 is a diagram illustrating a decoding sequence according to an exemplary embodiment of the present invention.

A decoder extracts information about grouping from a bit stream at step S702. Depending on an encoding method, information about grouping, such as group size, the set values of pass bits, whether grouping is performed according to an RLC method, or whether a single pass bit has been set for a group, can be extracted.

Whether each block has been coded is determined using the grouping information at step S710. If it is determined that the block has been coded, the symbol of the corresponding block is decoded at step S720. However, if it is determined that the block has not been coded, the value of the symbol of the corresponding block is generated or set using a predetermined value or a value predicted from a lower layer, etc., at step S730.

It may be easiest if the group size indicating the number of blocks included in a group is set to a constant. For the purpose of high efficiency, the optimal group size may be estimated and then included and transmitted in a slice header. The encoder side may actually code various group sizes and then include and transmit group size N having the smallest number of bits in the slice header. The decoder side can parse the remaining symbols based on the received group size.

The terms “unit,” “module” and “table” used in the present exemplary embodiment refer to software and hardware constituent elements, such as a Field Programmable Gate Array (FPGA) or an Application Specific Integrated Circuit (ASIC). The module performs functions. However, this does not mean that the module is limited to software or hardware. The module may be configured to exist in a storage medium which is addressable and may be configured to execute on one or more processing units. For example, the module may include constituent elements, such as software constituent elements, object-oriented software constituent elements, class constituent elements and task constituent elements, processes, functions, attributes, procedures, subroutines, segments of program code, drivers, firmware, microcodes, circuits, data, databases, data structures, tables, arrays, and parameters. Functions provided within the constituent elements and the modules may be combined with a smaller number of constituent elements and modules or may be separated into additional constituent elements and modules. Furthermore, the constituent elements and the modules may be implemented to execute on one or more CPUs within a device.

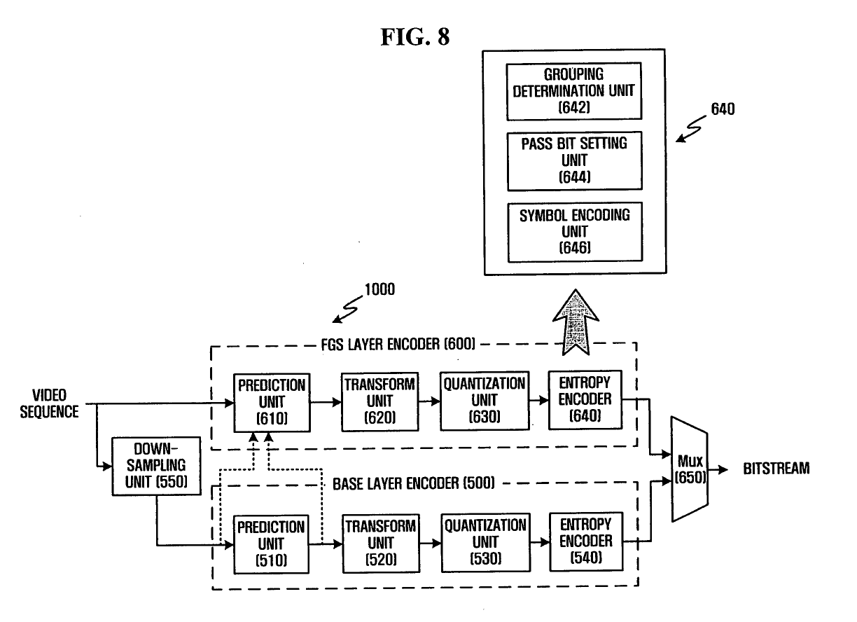

FIG. 8 is a block diagram illustrating the construction of the entropy encoding unit 1000 of an encoder according to an exemplary embodiment of the present invention.

An original video sequence is input to a Fine Granularity Scalability (FGS) layer encoder 600 and is then down-sampled (only when there is variation in resolution between layers) by a down-sampling unit 550. The down-sampled video sequence is input to a base layer encoder 500.

A prediction unit 610 obtains a residual signal by subtracting an image, which is predicted using a specific method, from a current block. The prediction method may include directional intra prediction, inter prediction, intra base prediction and residual prediction.

A transform unit 620 transforms the obtained residual signal using a spatial transform method such as DCT or wavelet transform, and generates a transform coefficient.

A quantization unit 630 quantizes transform coefficients based on a quantization step (the higher the quantization step, the higher the loss or data compression ratio), and generates quantization coefficients.

In the same manner as in the FGS layer encoder 600, the base layer encoder 500 also includes a prediction unit 510, a transform unit 520, and a quantization unit 530, which have the same functions as those of the prediction unit 610, the transform unit 620, and the quantization unit 630. However, the prediction unit 510 may not use intra base prediction or residual prediction.

An entropy encoder 640 performs lossless coding on the quantization coefficients and outputs an FGS layer bit stream. In a similar way, an entropy encoder 540 outputs a base layer bit stream.

A multiplexer (Mux) 650 multiplexes the FGS layer bit stream and the base layer bit stream, and generates a bit stream to be transmitted to a video decoder stage.

The FGS layer entropy encoder 640 will be described in detail below. The FGS layer entropy encoder 640 includes a grouping determination unit 642, a pass bit setting unit 644, and a symbol encoding unit 646.

The grouping determination unit 642 determines what group size will be used to group blocks within a corresponding slice or frame, or whether a pass bit is set for each symbol or for each group after grouping has been performed.

The pass bit setting unit 644 sets pass bits using the method which has been described with reference to FIGS. 3 to 6, based on the determined grouping method. The symbol encoding unit 646 does not perform coding on symbols that do not require coding according to the pass bit, and perform coding on the other symbols. The symbol encoding unit 646 may also perform coding on pass bits depending on the grouping method. Furthermore, the information about the group size and the grouping method, determined by the grouping determination unit 642, may be inserted into and coded in the header of a slice or frame.

In FIG. 8, the group-based encoding method is applied to the entropy encoder 640 of the FGS layer encoder 600. This is because the symbols of the blocks of an FGS layer are frequently either 0 or 1. Therefore, the method implemented in the entropy encoder 640 of the FGS layer encoder 600 may also be applied to the encoders of other layers.

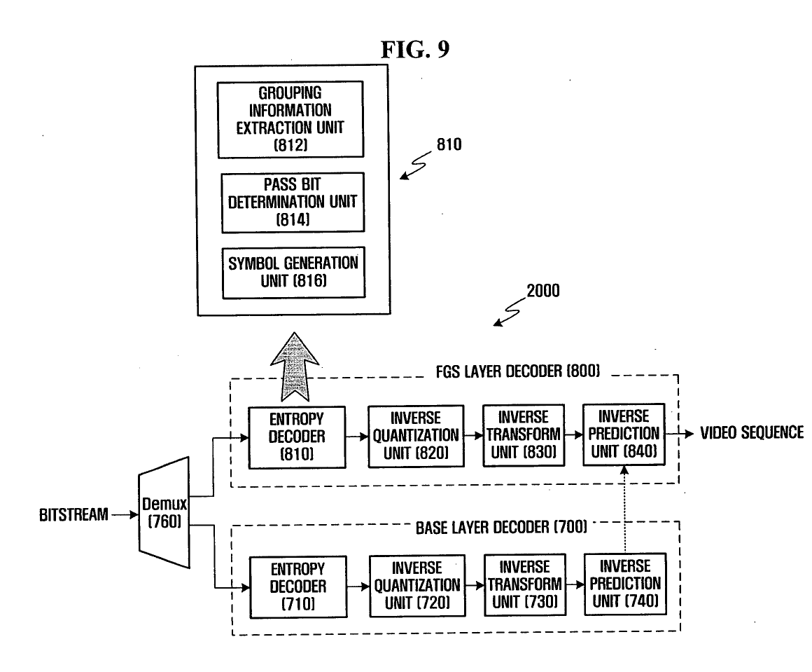

FIG. 9 is a block diagram illustrating the construction of the entropy decoding unit 2000 of a decoder according to an exemplary embodiment of the present invention.

An input bit stream is separated into an FGS layer bit stream and a base layer bit stream via a demultiplexer (Demux) 760. The FGS layer bit stream and the base layer bit stream are provided to an FGS layer decoder 800 and a base layer decoder 700, respectively.

An entropy decoder 810 restores quantization coefficients by performing lossless decoding using a method corresponding to that of the entropy encoder 640. The entropy decoder 810 includes a grouping information extraction unit 812, a pass bit determination unit 814, and a symbol generation unit 816.

The grouping information extraction unit 812 extracts information about group size and a grouping method from a bit stream. The information can be extracted from the head of a slice or frame because the information can be set on a slice or frame basis.

The pass bit determination unit 814 extracts pass bits based on the extracted group information and the grouping method, and determines whether the symbol of each block has been coded. The value of the symbol is coded depending on determination results, as described above with reference to FIG. 7. For example, in the case of a symbol for which a pass bit is set and which has not been coded on an encoder side, the symbol is set to have a predetermined value or value predictable from a lower layer because the value of the corresponding symbol has the predetermined value or predictable value.

An inverse quantization unit 820 performs inverse quantization on information about the restored symbol based on the quantization step used in the quantization unit 630.

An inverse transform unit 830 performs inverse transform on the inverse-quantized result using an inverse spatial transform method, such as inverse DCT transform or inverse wavelet transform.

An inverse prediction unit 840 obtains a prediction image, which has been obtained in the prediction unit 610, in the same manner and adds the obtained prediction image to the inverse transformed result, thus restoring a video sequence.

Like the FGS layer decoder 800, the base layer decoder 700 also has an entropy decoder 710, an inverse quantization unit 720, an inverse transform unit 730, and an inverse prediction unit 740, which have the same functions as those of the entropy decoder 810, the inverse quantization unit 820, the inverse transform unit 830, and the inverse prediction unit 840, respectively.

In FIG. 9, the group-based decoding method is applied to the entropy decoder 810 of the FGS layer decoder 800. This is because the symbols of the block of the FGS layer are frequently either 0 or 1. Therefore, the method implemented in the entropy decoder 810 of the FGS layer decoder 800 may also be applied to the decoders of other layers.

According to the present invention, the compression performance at a low bit rate can be improved at the time of block-based symbol coding.

According to the present invention, high compression efficiency can be provided for symbols having the repeated same values without requiring a compression process.

Although the exemplary embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method of coding blocks constituting a multi-layer video signal, the method comprising:
grouping at least two blocks having symbols that have values identical to a predetermined value into grouped blocks;
generating group-based symbols each indicating information about each of the grouped blocks; and
coding the group-based symbols.

2. The method of claim 1 further comprising, before the grouping, calculating a number of blocks to be grouped.

3. The method of claim 1, wherein the predetermined value is one of a first value and a value predicted from a lower layer of the multi-layer video signal.

4. The method of claim 1, wherein the generating the group-based symbols comprises setting a single pass bit for the symbols of the grouped blocks.

5. The method of claim 1, wherein the generating the group-based symbols comprises setting pass bits for the symbols of the grouped blocks, respectively; and the coding the group-based symbols comprises performing run-length coding (RLC) on the pass bits respectively set for the symbols.

6. The method of claim 1, wherein the predetermined value comprises a Coded Block Pattern (CBP) value of 0, the generating the group-based symbols comprises setting a pass bit for the grouped blocks when CBP values included in the at least two blocks are 0, and the coding the group-based symbols comprises not coding the CBP values of the at least two blocks.

7. The method of claim 1, wherein the predetermined value includes a residual prediction flag value of 1, the generating the group-based symbols comprises setting a pass bit for the grouped blocks when residual prediction flag values of the symbols included in the at least two blocks are 1, and the coding the group-based symbols comprises not coding the residual prediction flags of the at least two blocks.

8. The method of claim 1 further comprising including information about a number of blocks to be grouped or information about generating the group-based symbols in a header of a slice or in a header of a frame in which the blocks are included.

9. The method of claim 1, wherein the generating the group-based symbols comprises not coding the symbols, which are included in the at least two blocks, when the symbols have values identical to the predetermined value.

10. The method of claim 9, wherein the generating the group-based symbols comprises setting pass bits to distinguish between blocks that have not been grouped in the grouped blocks and blocks that have been grouped in the grouped blocks.

11. The method of claim 9, wherein the generating of group-based symbols comprises grouping a predetermined number of blocks if symbols of the predetermined number of blocks have values identical to the predetermined value.

12. A method of decoding blocks constituting a multi-layer video signal, the method comprising:
extracting grouping information about a grouping of blocks having symbols that have values identical to a predetermined value;
determining, in a determination, whether the blocks constituting the multi-layer video signal have been coded based on the extracted grouping information; and
extracting the predetermined value based on a result of the determination, and generating the blocks.

13. The method of claim 12, wherein the extracting the grouping information comprises extracting information about a number of blocks to be grouped or information about generating group-based symbols from a header of a slice or a header of a frame in which the blocks are included.

14. The method of claim 12, wherein the predetermined value is one of a first value and a value predicted from a lower layer of the multi-layer video signal.

15. The method of claim 12, wherein the determining whether the blocks have been coded comprises determining whether the blocks have been coded using a single pass bit set for the symbols of the grouping of blocks.

16. The method of claim 12, wherein the determining whether the blocks have been coded comprises:
extracting pass bits, which have been set for the symbols of the grouping of blocks, respectively, using run-length coding (RLC); and
determining whether the respective symbols of the grouped blocks have been coded using the extracted pass bits.

17. The method of claim 12, wherein the predetermined value is a Coded Block Pattern (CBP) value of 0, and
the generating the blocks comprises setting CBP values of the blocks to 0 without decoding when the blocks have symbols that have values identical to the predetermined value.

18. The method of claim 12, wherein the predetermined value is a residual prediction flag value of 1, and the generating the blocks comprises generating the blocks using residual energy of a lower layer of the multi-layer video signal, of the blocks without decoding when the blocks have symbols that have values identical to the predetermined value.

19. A video encoder for coding blocks constituting a multi-layer video signal, the video encoder comprising:
a grouping determination unit which determines a grouping of at least two blocks having symbols that have values identical to a predetermined value, into grouped blocks;
a pass bit setting unit which sets at least one pass bit for group-based symbols each indicating information about the grouped blocks; and
a symbol encoding unit coding the group-based symbols.

20. The video encoder of claim 19, wherein the grouping determination unit calculates a number of blocks to be grouped.

21. The video encoder of claim 19, wherein the predetermined value is one of a first value and a value predicted from a lower layer of the multi-layer video signal.

22. The video encoder of claim 19, wherein the pass bit setting unit sets a single pass bit for the symbols of the grouped blocks.

23. The video encoder of claim 19, wherein the pass bit setting unit sets pass bits for the symbols of the grouped blocks, respectively, and the symbol encoding unit performs run-length coding (RLC) on the pass bits set for the symbols, respectively.

24. The video encoder of claim 19, wherein the predetermined value comprises a Coded Block Pattern (CBP) value of 0, the pass bit setting unit sets a pass bit for the grouped blocks when CBP values included in the at least two blocks is 0, and the symbol encoding unit does not code the CBP values of the at least two blocks.

25. The video encoder of claim 19, wherein the predetermined value comprises a residual prediction flag having a value of 1, the pass bit setting unit sets the pass bit for the grouped blocks when residual prediction flag values of the symbols included in the at least two blocks are 1, and the symbol encoding unit does not code the residual prediction flags of the at least two blocks.

26. The video encoder of claim 19, wherein the symbol encoding unit includes information about a number of blocks to be grouped or information about generating the group-based symbols in a header of a slice or a header of a frame in which the blocks are included.

27. The video encoder of claim 19, wherein the symbol encoding unit does not code the symbols which are included in the at least two blocks when the symbols have values identical to the predetermined value.

28. The video encoder of claim 27, wherein the pass bit setting unit sets a pass bit to distinguish between blocks that have not been grouped and blocks that have been grouped.

29. The video encoder of claim 17, wherein the pass bit setting unit sets a pass bit so that a predetermined number of blocks is grouped when symbols of the predetermined number of blocks have values identical to the predetermined value.

30. A video decoder for decoding blocks constituting a multi-layer video signal, the video decoder comprising:
a grouping information extraction unit extracting information about a grouping of blocks having symbols that have values identical to a predetermined value;
a pass bit determination unit determining whether the blocks constituting the multi-layer video signal have been coded based on the extracted information; and
a symbol generation unit extracting the predetermined value based on a result of the determination, and generating the blocks.

31. The video decoder of claim 30, wherein the grouping information extraction unit extracts information about a number of blocks to be grouped or information about generating group-based symbols in a header of a slice or a header of a frame in which the blocks are included.

32. The video decoder of claim 30, wherein the predetermined value is one of a first value and a value predicted from a lower layer of the multi-layer video signal.

33. The video decoder of claim 30, wherein the pass bit determination unit determines whether the blocks have been coded using a single pass bit set for the symbols of the grouped blocks.

34. The video decoder of claim 30, wherein the pass bit determination unit extracts pass bits, which are set for the symbols of the grouped blocks, respectively, using run-length coding (RLC), and determines whether the respective symbols of the grouped blocks have been coded using the extracted pass bits.

35. The video decoder of claim 30, wherein the predetermined value is a Coded Block Pattern (CBP) value of 0, and the symbol generation unit sets CBP values of the blocks to 0 without decoding when the blocks have symbols that have values identical to the predetermined value.

36. The video decoder of claim 30, wherein the predetermined value is a residual prediction flag value of 1, and the symbol generation unit generates the blocks using residual energy of a lower layer of the multi-layer video signal, of the blocks without decoding when the blocks have symbols that have values identical to the predetermined value.
